(19) United States
(12) Patent Application Publication
(10) Pub. No.: US 2012/0167517 A1
(43) Pub. Date: Jul. 5, 2012

(54) THINSHELL COMPOSITE CONNECTOR

(76) Inventors: Antonio Reyes Ruiz, Wildomar, CA (US); Randy Morrison, Henderson, NV (US)

(21) Appl. No.: 13/072,291

(22) Filed: Mar. 25, 2011

Related U.S. Application Data
(60) Provisional application No. 61/460,368, filed on Dec. 31, 2010.

(51) Int. Cl. E04B 1/41; E04C 2/06; B29C 41/20; E04B 2/84

(52) U.S. Cl. 52/582.1; 52/699; 52/600; 264/261

(57) ABSTRACT

A structural member for facilitating quick and economical construction of pre-cast building elements comprising entire or partial panels such as walls, floors, ceilings, and roofs by combining metal stud framing with thin concrete or similar material for light-weight, low-cost, structurally strong panels. An illustrative structural member for constructing such pre-cast building panels is a segmented member made of a rigid material, such as a metal, that is secured to a stud by pressing a member including tangs through a cavity, by the insertion of fasteners through apertures in structural member tabs, or by adhesion or coalescence. The member may include upper tabs and apertures permitting the flow of concrete for additional structural strength. Reinforcement bars can be also incorporated. To reduce heat transfer and promote environmentally responsible and resource-efficient building, a break may be left between the stud and the concrete, with the break possibly filled by an insulative material.

### CROSS-REFERENCE TO RELATED APPLICATION

This application claims the benefit of U.S. Provisional Patent Application No. 61/460,368, filed Dec. 31, 2010.

### FIELD OF THE INVENTION

The present disclosure relates to members for the construction of buildings and, more particularly, to a structural member used to join a metal framing member, such as a stud or track, and concrete to form an entirety or a portion of a pre-cast building element such as a wall, floor, ceiling, roof, slab, soffit, or other building panel.

### BACKGROUND

Prefabricated structural elements for buildings such as walls, floors, ceilings, roofs, slabs, soffits, and the like allow economical construction. The strength of these elements depends on the integrity of the connection between the prefabricated element and other components of the building, such as steel studs.

U.S. Pat. No. 4,590,717 shows connecting prefabricated elements with hinges. U.S. Pat. No. 5,414,972 discloses a two-piece assembly in which projections that engage rebar in a structural member. U.S. Pat. No. 6,151,858 teaches a building construction system using horizontal and vertical beams having tabs which are enclosed by a concrete wall. U.S. Pat. No. 7,571,579 discloses a steel stud having equidistant holes that receive a continuous strip of structural members. Published Application No. US 2007/0,245,657 shows steel studs having flanges punched from the side of the stud that engage the cast concrete, and optionally embedded rebar, of a structural building element.

### SUMMARY OF THE DISCLOSURE

In one embodiment, an illustrative structural member for fabricating an entirety or a portion of a building element such as a pre-cast wall, floor, ceiling, or roof incorporates tangs in addition to a rigid central section having a lower portion and two or more lower tabs extending outwardly from the central section lower portion. The tangs are slightly bendable and extend outwardly from the central section at a point above the lower tabs. One or more upper tabs capable of receiving concrete may each extend from the central section at a point above the opposing tangs. The central section may include apertures permitting the flow of concrete prior to its setting and/or receiving rebar, prior to setting of the concrete

In another embodiment, a structural member for fabricating such an entire or partial building element incorporates one or more fastener apertures in each of two or more lower tabs extending outwardly from a rigid central section. In yet another embodiment, the structural member's lower tabs are secured to a stud by adhesion or coalescence in lieu of fasteners or tangs. As with the other embodiments, the central section may include apertures permitting the receipt of rebar and/or a flow of concrete prior to setting and upper tabs that increase the concrete-engaging surfaces.

Shapes for the central section of the structural member are numerous, and cross-sectional shapes include, but are not limited to, an inverted “V”-shape, a semi-circle, and one consisting of two vertical members and a horizontal member.

Also disclosed are methods of manufacturing an entire or portion of a building element such as pre-cast wall, floor, ceiling, or roof for a building using a plurality of these structural members. The members are segmented, as their lower tabs include ends, and facilitate the connection to metal framing members such as beams, joists, tracks, or studs, optionally having a “C” cross-section.

In one embodiment, apertures are cut or punched in standard light gauge metal studs, prior to or after the metal is formed into a stud, and the structural members are inserted into these apertures. A simple, light-duty punch press may be utilized for punching the apertures in the studs. Spacing of the apertures can vary depending on load to be borne by the building element. Alternatively the structural members may be applied to a stud by screws, rivets, welding, or virtually any other means of fastening.

Similarly, the structural members disclosed herein can be centrally and inexpensively manufactured by a simple tooling device located on-site or off-site. The structural members may be of a heavier gauge than the metal framing members and will make the connection to the concrete much stronger. The structural members may be made of any substance with the properties that allow its intended use, such as metal that is or is not galvanized, treated, anodized, painted, epoxy coated, or hardened. The structural members could be composed of carbon fiber or another sufficiently-rigid synthetic or composite material.

In a given wall assembly, concrete may be spaced from the metal framing member to provide a thermal break, as doing so reduces heat transfer and promotes “green,” or environmentally responsible, construction. Insulative material may be applied to the space between the concrete and metal framing.

It is possible to add bars or other reinforcement material for the consolidation of concrete. Widely-spaced structural members may be used to hold a heavy gauge wire or small diameter rebar. The cross-sectional shapes of the various illustrative embodiments make it practical to add a heavy-gauge wire along each metal framing member, enabling the fastening of a wire mesh reinforcement directly to the structure.

Their design allows the segmented structural members to stack or nest, so that a large number of them can be shipped together, reducing what could be a truckload of building materials to a shipment fitting into a single box.

Additional features of the disclosure will become apparent to individuals skilled in the art upon consideration of the following detailed description of the illustrative embodiments.

### BRIEF DESCRIPTION OF THE DRAWINGS

The detailed description particularly refers to the accompanying figures in which:

FIG. 1 is an isometric view of an illustrative structural member for fabrication of an entire or partial building element such as a pre-cast wall, ceiling, floor, roof, or other building panel;

FIG. 2 is a perspective view of an illustrative structural member for fabrication of an entire or partial pre-cast building element which has a cross-sectional shape consisting of two generally vertical members and one generally horizontal member;

FIG. 3 is a perspective view of an illustrative structural member for fabrication of an entire or partial pre-cast building element which has a semi-circular cross-sectional shape;

FIG. 4 is an isometric view of the structural member of FIG. 1 inserted into an aperture in a stud having a “C” cross section;

FIG. 5 is a cross-sectional view of the structural member of FIG. 2 inserted into an opening in a stud;

FIG. 6 is a cross-sectional view of a section of a pre-cast building element where the structural member of FIG. 2 is inserted into a stud that is flush with a building panel; and

FIG. 7 is a cross-sectional view of the pre-cast building element section of FIG. 6 where an insulating spacer is between the stud and the building panel.

### DESCRIPTION OF THE ILLUSTRATIVE EMBODIMENTS

For the purposes of promoting and understanding the principles of the invention, reference will now be made to one or more embodiments illustrated in the drawings and specific language will be used to describe the same.

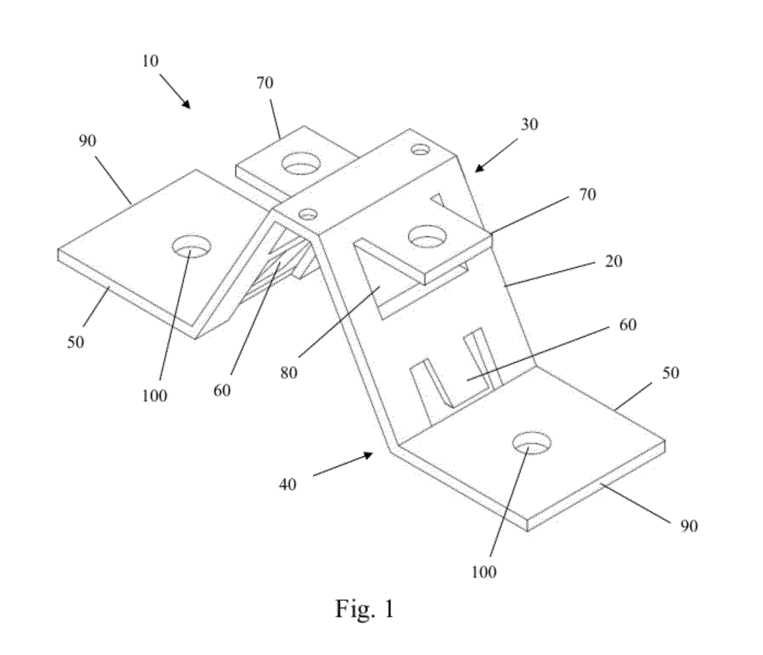

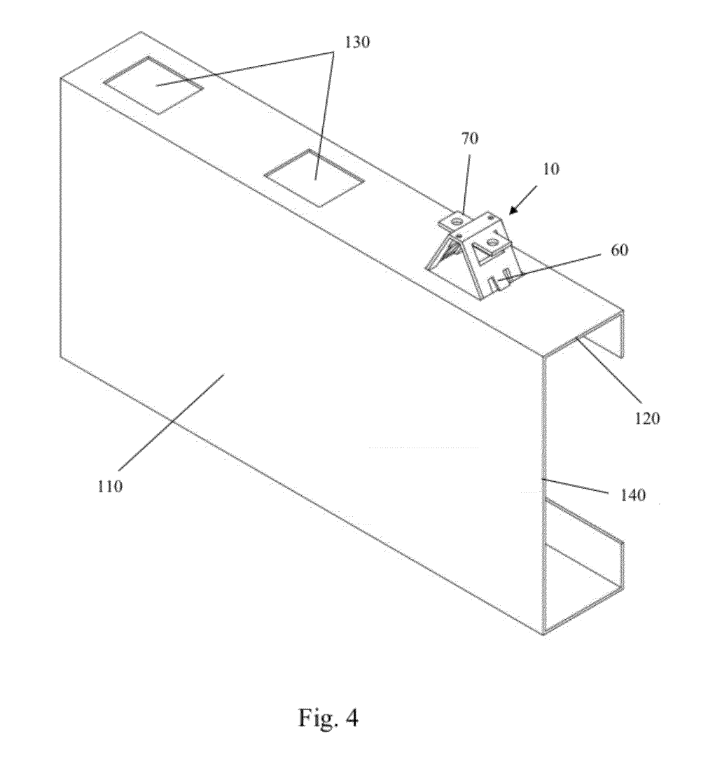

FIGS. 1 through 3 depict a structural member 10 for fabricating the entirety or a portion of a pre-cast building element such as a wall, floor, ceiling, roof, or other building panel. As may be seen in these figures, structural member 10 comprises a rigid central section 20 having an upper pre-cast concrete receiving surface 30 and a lower portion 40. Two or more lower tabs 50 extend outwardly from the central section's lower portion 40, and slightly-bendable opposing tangs 60 each extend outwardly from the central section 20 at a point above the lower tabs 50. As depicted in FIGS. 1 and 4, one or more upper tabs 70 may each extend outwardly from the central section 20 at a point above the opposing tangs 60. In all embodiments incorporating upper tabs 70, the upper tabs 70 may, but need not, be parallel with the lower tabs 50, and the upper tabs 70 as well as the tangs 60 may be formed from the central section 20, rather than comprising separate components attached thereto.

As the structural member 10 passes through an opening in a metal framing member such as a stud, the tangs 60 bend inward slightly and retract, and then spring back into their original position once the insertion is completed. The protuberances of the tangs 60 then serve as a “stop” to the user and prevent accidental removal of the member 10. Different tang 60 widths are envisioned, with embodiments preferably in the range of approximately 1⅝″ to 3″.

The tangs 60 extend outwardly from the central section 20, away from the interior defined by the shape of the central section 20 and preferably on opposing sides of the central section 20. In at least some illustrative embodiments, the tangs 60 extend along the same horizontal axis as the lower tabs 50 and upper tabs 70. The angle at which the tangs 60 may extend from the central section 20 may vary, but can be in the range of 10° to 20°.

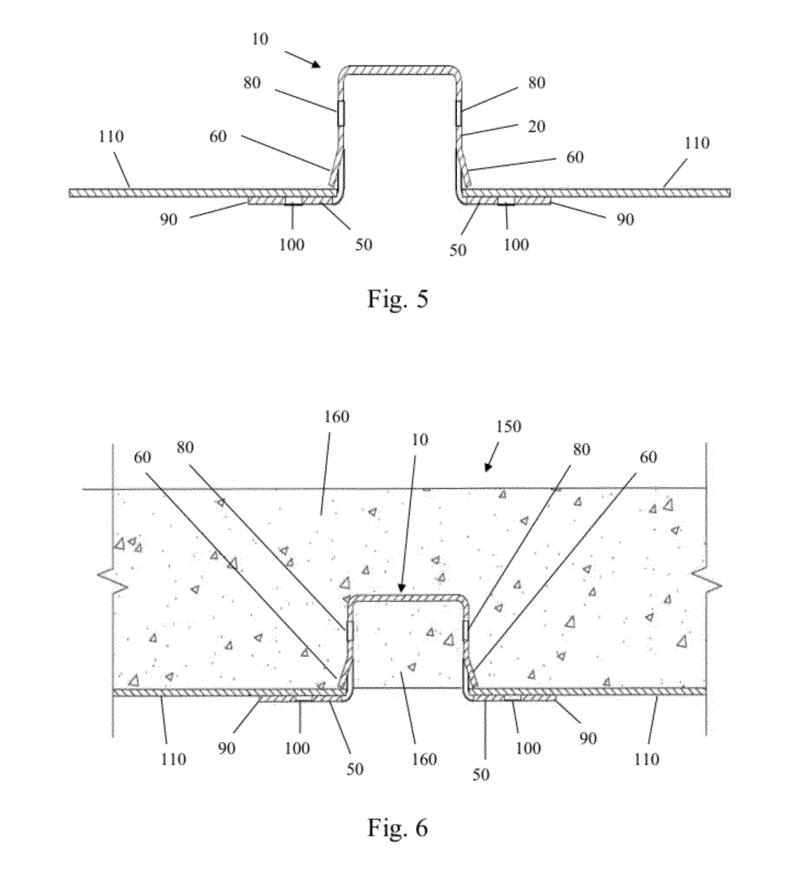

The use of the term tang 60 herein is inclusive and includes many means of locking the structural member 10 in place through apertures in metallic framing members such as studs or beams (FIGS. 4 through 7). These means may entail the use of protrusions, flaps, notches, bumps, or any other shape capable of retaining the structural member 10 in a metal framing member once a portion of the member 10 passes through an opening in the framing member. In one embodiment, “teardrop” shape bump-outs on the structural member central sections 20 are used to hold installed structural members 10 in place in metal framing members.

The structural members 10 are segmented, with each lower tab 50 having an end 90. This permits the user to space the structural members 10 in a stud at any of a multitude of possible intervals.

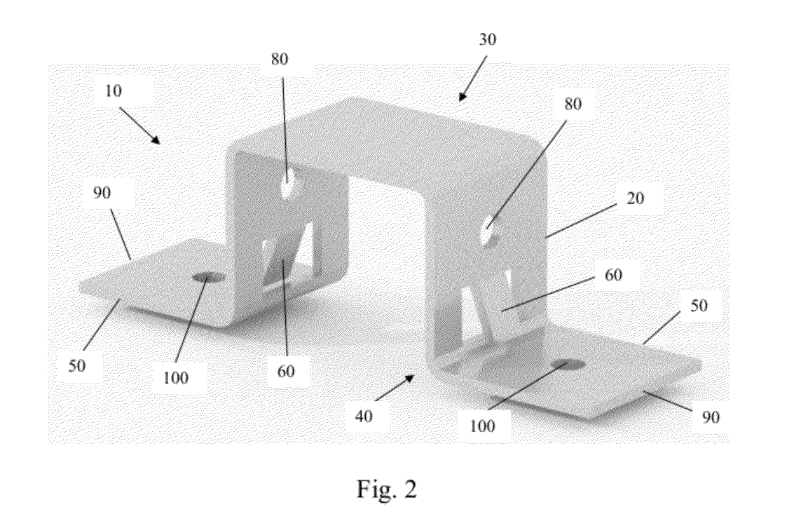

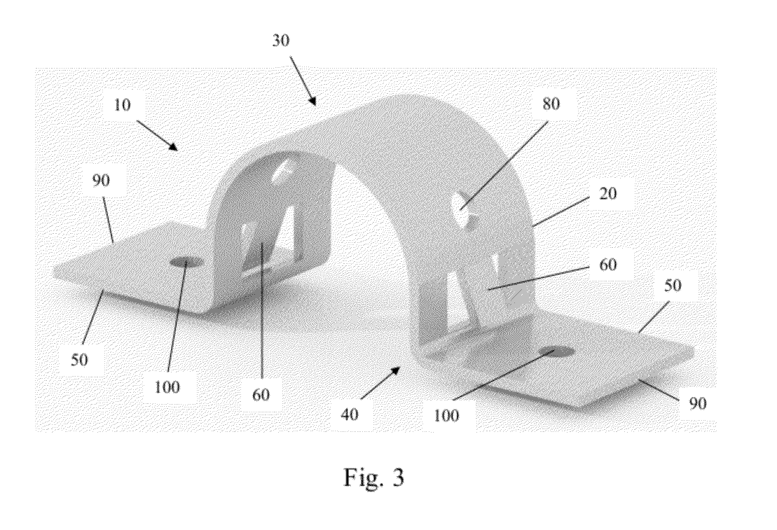

Countless shapes for the central section 20 of the structural member 10 are possible in all embodiments, with illustrative cross-sectional shapes including, but not being limited to, an “A” or inverted “V”-shape (FIG. 1), which may or may not terminate at a sharp angle or point; a semi-circle (FIG. 3); and one consisting of two generally vertical members and a generally horizontal member (FIG. 2). The techniques for fabricating an entire or partial building element such as a pre-cast wall, floor, ceiling, or roof disclosed herein may be applied regardless of the shape of the central section 20.

The structural members 10 may be of any desired size, so long as the part of the central section 20 having the tangs 60 is capable of passing through the desired aperture in a stud. The structural member 10 may be composed of any metal or another synthetic or composite material, such as carbon-fiber, sufficiently rigid to allow the member's intended use, including the need for the tangs 60 (if any) to be slightly-bendable so they “lock” into place. The member 10 may be finished, and the disclosure contemplates a structural member 10 which is epoxy-coated, painted, anodized, galvanized, or finished with any other physical form that achieves reinforcement. Metal tooling machines well known in the art may be used to form the structural member 10.

In this embodiment, as with all others, the central section 20 may include one or more apertures 80 to permit the flow of a composite construction material, such as concrete, around the structural member 10. This, in addition to the concrete flowing around the tangs 60, promotes even greater strength of the constructed pre-cast building panel. As discussed below, the apertures 80 also allow for the use of rebar or another reinforcement material.

Each lower tab 50 of structural member 10 has an end 90 and may include one or more apertures 100, in addition to or rather than tangs in the central section 20, in an alternate embodiment. Apertures 100 are used for fastening the structural member 10 to a metal framing member such as a stud, joist, or track. As used herein, the term metal framing member is inclusive and encompasses any metal member that is capable of defining an edge of a building element. Among the means of connecting this embodiment of the structural member 10 to a stud are screws, bolts, nuts, adhesive, tape, nails, pop-type rivets, and virtually any other way of connecting one rigid body to another. Alternatively, the lower tabs 50 may be capable of being secured to a stud by adhesion or coalescence.

Regardless of shape, for purposes of building construction, and prior to the pouring of concrete, the structural member 10 is secured to a metal framing member. As shown in FIG. 4, the metal framing member 110 may be C-shaped, but need not be and only need have a flange 120 capable of accommodating and connecting to the structural members 10 through apertures 130 cut in the flange 120. The apertures 130 may be preformed in metal prior to the metal being formed into a framing member 110. The metal framing members 110 used can be as light as 18 or 20 gauge, while the structural members 10 can consist of 16 gauge material. Metal framing members having a variety of central member or “web” 140 heights may be employed, and those used in certain embodiments vary from approximately 3⅝″ to 12″ in height, with greater stud web 140 heights also envisioned.

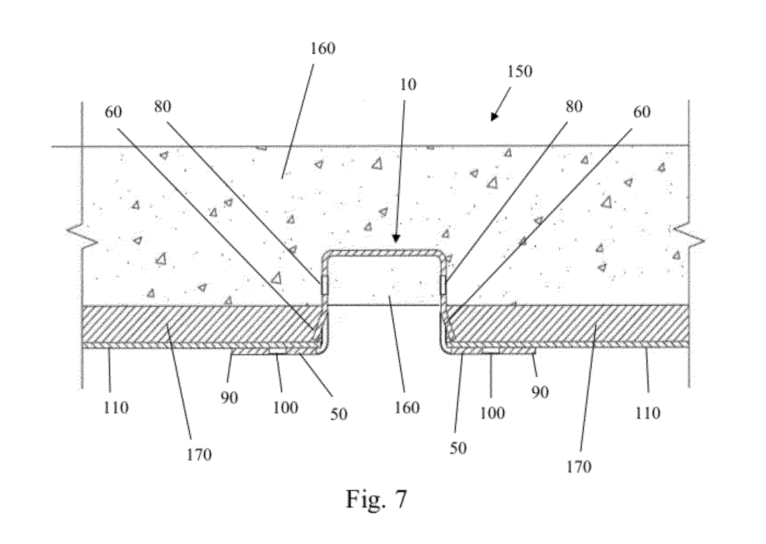

The disclosed embodiments may be utilized for quick and cost-effective construction of a portion or entirety of a building element comprising a wall or other building panel such as a floor, ceiling, or roof, as depicted in FIGS. 6 and 7. In one embodiment, such a wall or other panel 150 would comprise cast concrete 160 or another composite construction material, a metal framing member 110 having a plurality of apertures 130 cut therein, and a plurality of segmented structural members 10. The structural members 10 are of a design disclosed herein, including those illustrated in FIGS. 1-3. Once installed as shown in FIG. 4, the central section 20 is on the side of the metal framing member's flange 120 opposite the web 140 of the framing member 110. The wall or other building structure panel 150 will comprise cast concrete 160 or another composite construction material, with the concrete 160 adhering to at least a portion of the structural members 10. It should be noted that the structural members 10 may be designed to extend deeper into the concrete 160 due to particular engineering requirements.

Alternatively, a building element comprising a pre-cast wall, ceiling, floor, roof, or other building panel 150 may be constructed using any embodiment of the structural members 10 and securing them to the metal framing member 110 by inserting fasteners through the member lower tab apertures 100 and into corresponding apertures in the metal framing member 110. As noted, fasteners known in the art such as screws, rivets, bolts, and anchors may be utilized.

Instead of fasteners, adhesion or coalescence-based fabrication may be used to construct a pre-cast wall, ceiling, floor, roof, or other building panel 150 using the structural members 10 disclosed herein. In this embodiment, welding or commercial adhesives are employed to connect the lower tabs 50, or another section, of the structural members 10 to a metal framing member 110, without a need for apertures 100 in the lower tabs 50.

The spacing of the stud apertures 130 can vary, with factors such as pull-out strength, shear values, seismic load and design, and wind load among those that may be taken into consideration. While often rectangular, these apertures 130 in the metal framing member 110 may take practically any shape, so long as the shape permits a section of each member's central section 20 to pass through the desired aperture 130.

An illustrative method of manufacturing a pre-cast wall, ceiling, floor, roof, or other building panel 150 includes the steps of cutting a plurality of apertures 130 in a metal framing member 110 prior to or after the framing member is formed from metal; providing a plurality of segmented structural members 10 having opposing tangs 60; securing the structural members 10 to the metal framing member 110 by pressing or otherwise forcing the members 10 through the apertures 130 in the metal framing member 110 such that the respective opposing tangs 60 hold each member 10 in place in the metal framing member 110; providing a mold for casting concrete in a desired building structure or panel 150 geometry; pouring or otherwise introducing concrete 160 into the mold so that the concrete surrounds at least a portion of each of the structural members 10; and removing the mold, preferably once the concrete 160 has set.

More particularly, the structural members 10 are pushed through the metal framing member apertures 130 from the apertures' web 140 side, and once installed, the central section 20 of each structural member 10 will be on the side of the metal framing member's flange 120 opposite the framing member web 140. Techniques known in the art, such as a light-duty punch press, may be utilized for punching the apertures 130 in the metal framing members 110.

Another illustrative method of manufacturing a pre-cast wall, ceiling, floor, roof, or other building panel 150 utilizes segmented structural members 10 with apertures 100 in their lower tabs 50. The structural members 10 are secured to the metal framing members 110 by inserting fasteners through structural member apertures 100 and into corresponding apertures in the metal framing members 110.

A drill, punch, or other simple hole-forming device may be used to make any needed apertures in the lower tabs 50 and the metal framing members 110. Again, the apertures may be cut in metal prior to it being formed into a framing member 110. The fasteners for securing such structural members 10 to the metal framing members 110 are inclusive and include devices such as rivets, screws, bolts, and anchors. Alternatively, adhesion or coalescence techniques well known to those in the construction art, such as welding or the use of commercial adhesives, may be employed in lieu of using fasteners or tangs. A considerable advantage in that case is that apertures for receiving the structural members 10 need not be cut into the metal framing members 110.

It should be understood that all of the method steps herein are merely exemplary of their respective embodiments. Other steps may be added, while some may be omitted. Variations in step sequence are envisioned, and the order of the steps may be changed while remaining within the scope of the present invention.

Regardless of the particular embodiment of structural member 10 used or the particular pre-casting method followed, the concrete 160 of any fabricated wall, floor, ceiling, roof, or other panel 150 may be spaced (FIG. 7) from the metal framing member 110, rather than being flush with it (FIG. 6). This is important for purposes of providing a thermal break and reducing heat transfer. This brake, for example, may be a ¼″ or ½″ gap. The break may, in turn, be filled with an insulative material 170 prior to the introduction of concrete, or the insulating spacer may simply consist of open space. Potential insulative material 170 includes fiberglass and polystyrene foam. Such a construction technique promotes environmentally responsible and resource-efficient buildings.

One or more additional members may run through holes in the structural members 10 to allow supplemental reinforcement, adding pullout resistance from the concrete 160. These members also may permit additional spacing between the structural members 10. More particularly, it is possible to pass rebar or some other reinforcement material through the apertures 80 in the central section 20, in the manner shown in FIG. 4 of U.S. Pat. No. 7,571,579, which is incorporated herein by reference. Such rebar may be one row of a rebar grid that increases the structural integrity of the building structure after it has been cast and cured. The possible spacing and cross-sectional shapes of the various illustrative structural members 10 also make it practical to add a heavy-gauge wire down each metal framing member 110, enabling the fastening of a wire mesh reinforcement. Widely-spaced members 10, such as those approximately 6″ apart, may be used to hold a heavy-gauge wire or small diameter rebar in place. Other means of reinforcement such as fiber choppings may be used.

Advantageously, as their compact design allows the segmented structural members 10 to nest, a large number of them can be shipped together in one box, permitting fabrication of an entire or partial building element such as a wall, floor, ceiling, roof, or other panel 150 at a job site or at another location. The pre-cast panel fabrication may be done in a vertical plane, which will conserve needed space, be it at the site or other location.

While the invention has been illustrated and described in detail in the foregoing drawings and description, the same is to be considered as illustrative and not restrictive in character, it being understood that only illustrative embodiments thereof have been shown and described and that all changes and modifications which are within the scope of the claimed subject matter are desired to be protected. As just one example, the term “concrete,” as used herein, is intended to include not just conventional concrete, but any other material from which prefabricated building structural components may be formed by being poured into a mold and that cures over time. Thus, this could include, for example, plastics or composite materials.

What is claimed is:

1. A structural member for fabricating a pre-cast wall, floor, or roof element for a building comprising:
a rigid central section having an upper concrete receiving surface and a lower portion;
two or more lower tabs extending outwardly from the central section lower portion; and
slightly-bendable opposing tangs each extending outwardly from the central section at a point above the lower tabs.

2. The structural member of claim 1 further comprising one or more upper tabs formed from the central section and extending from the central section at a point above the opposing tangs.

3. The structural member of claim 1 further comprising one or more apertures in the pre-cast concrete receiving surface of the central section.

4. The structural member of claim 1 wherein the central section is generally semicircular or an inverted “V” in cross-sectional shape.

5. The structural member of claim 1 wherein the cross-sectional shape of the central section is comprised of at least two generally vertical members and at least one generally horizontal member.

6. The structural member of claim 1 further comprising a metal framing member having an aperture to which the structural member is secured via the aperture.

7. A structural member for fabricating a pre-cast wall, floor, or roof element for a building comprising:
a rigid central section having an upper concrete receiving surface and a lower portion; and
two or more lower tabs extending outwardly from the central section lower portion
each lower tab having an aperture.

8. The structural member of claim 7 further comprising one or more upper tabs each extending from the central section at a point above the lower tabs.

9. The structural member of claim 7 further comprising one or more apertures in the concrete receiving surface of the central section.

10. The structural member of claim 7 wherein the central section is generally semicircular or an inverted “V” in cross-sectional shape.

11. The structural member of claim 7 wherein the cross-sectional shape of the central section is comprised of at least two generally vertical members and at least one generally horizontal member.

12. The structural member of claim 7 further comprising a metal framing member to which the structural member is secured.

13. A pre-cast wall, floor, or roof element for a building comprising:
a cast concrete portion of a wall, floor, or roof for a building;
a metal framing member having a plurality of apertures therein; and
a plurality of segmented structural members, each comprising:
a rigid central section having an upper concrete receiving surface and a lower portion;
two or more lower tabs extending outwardly from the central section lower portion; and
slightly-bendable opposing tangs each extending outwardly from the central section at a point above the lower tabs,
whereby
the concrete is adhered to the structural members; and
the metal framing member and the opposing tangs of each of the plurality of structural members hold the member to the metal framing member.

14. The pre-cast wall, floor, or roof element for a building of claim 13 wherein the structural members each further comprise one or more upper tabs each extending from the central section at a point above the opposing tangs.

15. The pre-cast wall, floor, or roof element for a building of claim 13 wherein the central section of each of the structural members further comprises one or more apertures through which one or more reinforcement bars or other reinforcing material passes.

16. The pre-cast wall, floor, or roof element for a building of claim 13 wherein the concrete is flush with the metal framing member.

17. The pre-cast wall, floor, or roof element for a building of claim 13 wherein the concrete is spaced from the metal framing member.

18. The pre-cast wall, floor, or roof element for a building of claim 17 further comprising an insulating material or spacer between the metal framing member and the concrete.

19. A pre-cast wall, floor, or roof element for a building comprising:
a cast concrete portion of a wall, floor, or roof for a building;
a metal framing member having a plurality of apertures therein; and
a plurality of segmented structural members, each comprising:
a rigid central section having an upper pre-cast concrete receiving surface and a lower portion; and
two or more lower tabs extending from the central section lower portion with an aperture in each lower tab,
whereby
the concrete is adhered to the structural members; and
the structural members are secured to the metal framing member by fasteners connecting the member lower tab apertures to corresponding apertures in the metal framing member.

20. The pre-cast wall, floor, or roof element for a building of claim 19 wherein the structural members each further comprise one or more upper tabs each extending from the central section at a point above the lower tabs.

21. The pre-cast wall, floor, or roof element for a building of claim 19 wherein the central section of each of the structural members further comprises one or more apertures through which one or more reinforcement bars or other reinforcing material passes.

22. The pre-cast wall, floor, or roof element for a building of claim 19 wherein the concrete is flush with the metal framing member.

23. The pre-cast wall, floor, or roof element for a building of claim 19 wherein the concrete is spaced from the metal framing member.

24. The pre-cast wall, floor, or roof element for a building of claim 23 further comprising an insulating material or spacer between the metal framing member and the concrete.

25. A pre-cast wall, floor, or roof element for a building comprising:
a cast concrete portion of a wall, floor, or roof for a building;
a metal framing member having a plurality of apertures therein; and
a plurality of segmented structural members, each comprising:
a rigid central section having an upper pre-cast concrete receiving surface and a lower portion; and
two or more lower tabs extending outwardly from the central section lower portion,
whereby
the concrete is adhered to the structural members and the metal framing member; and
the structural members are secured to the metal framing member by adhesion or coalescence.

26. The pre-cast wall, floor, or roof for a building of claim 25 wherein the structural members each further comprise one or more upper tabs each extending from the central section at a point above the lower tabs.

27. The pre-cast wall, floor, or roof element for a building of claim 25 wherein the central section of each of the structural members further comprises one or more apertures through which one or more reinforcement bars or other reinforcing material passes.

28. The pre-cast wall, floor, or roof for a building of claim 25 wherein the concrete is flush with the metal framing member.

29. The pre-cast wall, floor, or roof for a building of claim 25 wherein the concrete is spaced from the metal framing member.

30. The pre-cast wall, floor, or roof for a building of claim 29 further comprising an insulating material or spacer between the metal framing member and the concrete.

31. A method of manufacturing a pre-cast wall, floor, or roof element for a building comprising the steps of:
providing a metal framing member having a plurality of apertures;
providing a plurality of segmented structural members, each comprising:
a rigid central section having an upper pre-cast concrete receiving surface and a lower portion;
two or more lower tabs extending outwardly from the central section lower portion; and
slightly-bendable opposing tangs each extending outwardly from the central section at a point above the lower tabs;
securing the structural members to the metal framing member by pressing the plurality of segmented structural members through the apertures in the metal framing member such that the opposing tangs hold the members to the metal framing member;
providing a mold for casting concrete in a desired building structure geometry;
introducing concrete into the mold so that the concrete surrounds at least a portion of the central section; and
removing the mold.

32. The method of claim 31 wherein the structural members further comprise one or more upper tabs each extending from the central section at a point above the opposing tangs.

33. The method of claim 31 further comprising the step of positioning an insulating material or spacer against the metal framing member prior to the step of introducing the concrete.

34. A method of manufacturing a pre-cast wall, floor, or roof element for a building comprising the steps of:
providing a metal framing member having a plurality of apertures;
providing a plurality of segmented structural members, each comprising:
a rigid central section having an upper pre-cast concrete receiving surface and a lower portion; and
two or more lower tabs extending from the central section lower portion with an aperture in each lower tab;
securing the structural members to the metal framing member by inserting fasteners through the member lower tab apertures and into corresponding apertures in the metal framing member;
providing a mold for casting concrete in a desired building structure geometry;
introducing concrete into the mold so that the concrete surrounds at least a portion of the central section; and
removing the mold.

35. The method of claim 34 wherein the structural members further comprise one or more upper tabs each extending from the central section at a point above the opposing tangs.

36. The method of claim 34 wherein the fasteners comprise rivets.

37. The method of claim 34 wherein the fasteners comprise screws.

38. The method of claim 34 further comprising the step of positioning an insulating material or spacer against the metal framing member prior to the step of introducing the concrete.

39. A method of manufacturing a pre-cast wall, floor, or roof element for a building comprising the steps of:
providing a metal framing member;
providing a plurality of segmented structural members, each comprising:
a rigid central section having an upper pre-cast concrete receiving surface and a lower portion; and
two or more lower tabs extending outwardly from the central section lower portion,
securing structural members to the metal framing member by adhesion or coalescence;
providing a mold for casting concrete in a desired building structure geometry;
introducing concrete into the mold so that the concrete surrounds at least a portion of the central section; and
removing the mold.

40. The method of claim 39 further comprising the step of positioning an insulating material or spacer against the metal framing member prior to the step of introducing the concrete.
